(19) United States
(12) Patent Application Publication
(10) Pub. No.: US 2026/0186870 A1
(43) Pub. Date: Jul. 2, 2026

(54) CUSTOMIZABLE DIGITAL CONTENT PROCESSING WORKFLOWS USING USER-DEFINED CONFIGURATION FILES

(71) Applicant: Microsoft Technology Licensing, LLC, Redmond, WA (US)

(72) Inventors: Sneha Bhupindersingh TULI, Aldie, VA (US); Shreyas KUMARI, Redmond, WA (US); Dragos Daniel BOIA, Seattle, WA (US); Hardik GOEL, Seattle, WA (US); Jacek Andrzej CZERWONKA, Sammamish, WA (US); Nihar Hasmukhbhai PATEL, Chelmsford, MA (US); Ta Chien CHANG, Redmond, WA (US)

(21) Appl. No.: 19/002,966

(22) Filed: Dec. 27, 2024

(51) Int. Cl. G06F 9/54; G06F 8/71; G06F 40/40

(52) U.S. Cl. CPC G06F 9/542; G06F 8/71; G06F 40/40; G06F 2209/543

(57) ABSTRACT

A task automation assistant accesses a configuration file. The configuration file defines the trigger event, wherein the trigger event initiates a sequence of processing operations. The configuration file defines user-defined instructions that define a processing task that the language model is to perform on the digital content and define inputs and a description of a desired output. In response to detecting the trigger event, the task automation assistant retrieves the digital content identified in the configuration file using content-identifying information included in the configuration file. The task automation assistant transmits, to a language model, the digital content and the user-defined instructions from the configuration file. The task automation assistant receives, from the language model, an output in response to transmitting the user-defined instruction and the digital content. The task automation assistant processes the output from the language model according to output instructions defined in the configuration file.

### BACKGROUND

Application development systems often provide automated workflows that utilize generative language models to process inputs for client systems. One example of an automated workflow is processing a pull request, which generates reports that explain changes to program code when it is updated. For example, the original and updated codes are input to a language model, which identifies and explains the differences between the original and the updated code.

### SUMMARY

In some aspects, the techniques described herein relate to a system for processing digital content responsive to a trigger event, including: a user-defined configuration file stored in memory defining: the trigger event, wherein a detection of the trigger event initiates a sequence of processing operations; content-identifying information that identifies the digital content in response to detection of the trigger event, wherein the content-identifying information identifies a location of the digital content; and user-defined instructions that define a processing task that a language model is to perform on the digital content, wherein the user-defined instructions define inputs to the language model and a description of a desired output to the language model; and output processing instructions that define at least one action to be executed on an output of the language model; and a task automation assistant stored in memory and executable by a processor to: in response to detecting the trigger event, retrieve the digital content identified in the user-defined configuration file from the identified location using the content-identifying information; input, to the language model, the digital content and the user-defined instructions from the user-defined configuration file; and receive the output from the language model specified in the description of the desired output in response to transmission of the user-defined instruction and the digital content. process the output from the language model according to the output processing instructions defined in the user-defined configuration file.

In some aspects, the techniques described herein relate to a method for processing digital content responsive to trigger a trigger event, including: accessing a configuration file stored in memory, the configuration file defining: the trigger event, wherein a detection of the trigger event initiates a sequence of processing operations; content-identifying information that identifies the digital content that is to be analyzed by a language model in response to detection of the trigger event, wherein the content-identifying information identifies a location of the digital content; user-defined instructions that define a processing task that the language model is to perform on the digital content, wherein the user-defined instructions define inputs to the language model and a description of a desired output to the language model; in response to detecting the trigger event, retrieving the digital content identified in the configuration file using the content-identifying information included in the configuration file; transmitting, to a language model, the digital content and the user-defined instructions from the configuration file; and receiving, from the language model, an output specified in the description of the desired output in response to transmitting the user-defined instruction and the digital content.

In some aspects, the techniques described herein relate to one or more tangible processor-readable storage media embodied with instructions for executing on one or more processors and circuits of a computing device a process for processing digital content responsive to a trigger event, the process including: accessing a configuration file stored in memory, the configuration file defining: the trigger event, wherein a detection of the trigger event initiates a sequence of processing operations; content-identifying information that identifies the digital content that is to be analyzed by a language model in response to detection of the trigger event, wherein the content-identifying information identifies a location of the digital content; user-defined instructions that define a processing task that the language model is to perform on the digital content, wherein the user-defined instructions define inputs to the language model and a description of a desired output to the language model; in response to detecting the trigger event, retrieving the digital content identified in the configuration file using the content-identifying information included in the configuration file; transmitting, to a language model, the digital content and the user-defined instructions from the configuration file; receiving, from the language model, an output specified in the description of the desired output in response to transmitting the user-defined instruction and the digital content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which a digital content processing system processes digital content according to processing steps of an automated workflow specified in a user-defined configuration file responsive to detecting a trigger event.

FIG. 2 illustrates an example computing environment in which a task automation assistant processes digital content according to processing steps of an automated workflow specified in a user-defined configuration file responsive to detecting a trigger event.

FIG. 3 illustrates examples of operations that process digital content responsive to a trigger event, comprising.

FIG. 4 illustrates an example computing device for implementing the described technology.

### DETAILED DESCRIPTION

Automated workflows provided by application development systems are predefined and are not adaptable to specific user (e.g., client computing system) contexts. To execute an automated workflow, the application development system accesses program code corresponding to the automated workflow and executes the program code to perform operations of the automated workflow. Operations may include analyzing input data, generating prompts for and/or processing output of machine learning models (e.g., language models), and/or other operations of the end-to-end process of the automated workflow. However, users may vary in their requirements for how workflows are initiated (e.g., manually triggered or automatically triggered under specific conditions) and how workflows are processed (e.g., specific language model inputs (e.g., prompts), specific input data, specific output formatting, etc.).

Although existing automated workflow tools may provide a variety of predefined automated workflows, presently available automated workflow tools do not provide automated workflows that satisfy users'specific requirements, which may differ widely from one user to another. In some scenarios, a predefined automated workflow may initially be adequate for a user but may be rendered inadequate as the user's requirements evolve. For example, the user initially uses a predefined automated workflow, applicable to all users of the application development system, to perform operations at a time each day as selected by the user. If the user desires to modify the predefined automated workload in some way, such as to implement a security measure requiring additional manual approval before initiating the automated workflow at the selected time, to include further processing of the workflow (e.g., formatting, etc.), or to change input data, etc., such modification of workflows to user-specific needs is typically prohibited.

In conventional predefined automated workflows, users seeking changes to the predefined automated workflows have to perform additional processing on the computing systems of the user or generate customized logic (e.g., program instructions) that modifies the predefined automated workflows for a specific purpose. Generation of the customized logic may require extensive intervention by operators (e.g., programmers) of the application development system or of the user's computing system.

The described technology introduces a user-defined configuration file that allows users to define customized automated workflows to be executed by the application development system. The user-defined configuration file includes user-customizable parameters defining an automated workflow. The parameters include a trigger event that initiates a sequence of processing operations that includes, for example, preparing inputs to a language model, passing the inputs to the language model and instructing the language model to execute a particular processing task on digital content included in the inputs, and processing outputs received from the machine learning model. The trigger event defines triggering criteria that, when satisfied, trigger the automatic implementation of the corresponding automated workflow defined in or otherwise referenced by the user-defined configuration file.

The user-customizable configuration file of the described technology enables a user to easily define parameters for customizable automated workflows specific to the computing context and preferences of the user. As a result, the user-customizable configuration file of the described technology adds functionality to the application development system by enabling the application development system to perform additional customizable user-specific automated workflows beyond the predefined set of automated workflows of conventional application development systems that apply to all users of the application development system. Also, usage of the user-customizable configuration file provides a format by which all users of the application development system may define parameters for customizable automated workflows without requiring the generation of or modification of programming code on the application development system or of the user's computing system. Further, usage of the user-customizable configuration file may reduce the usage of processing resources of the application development system compared to generating and executing separate programming code for each of a variety of automated workflows.

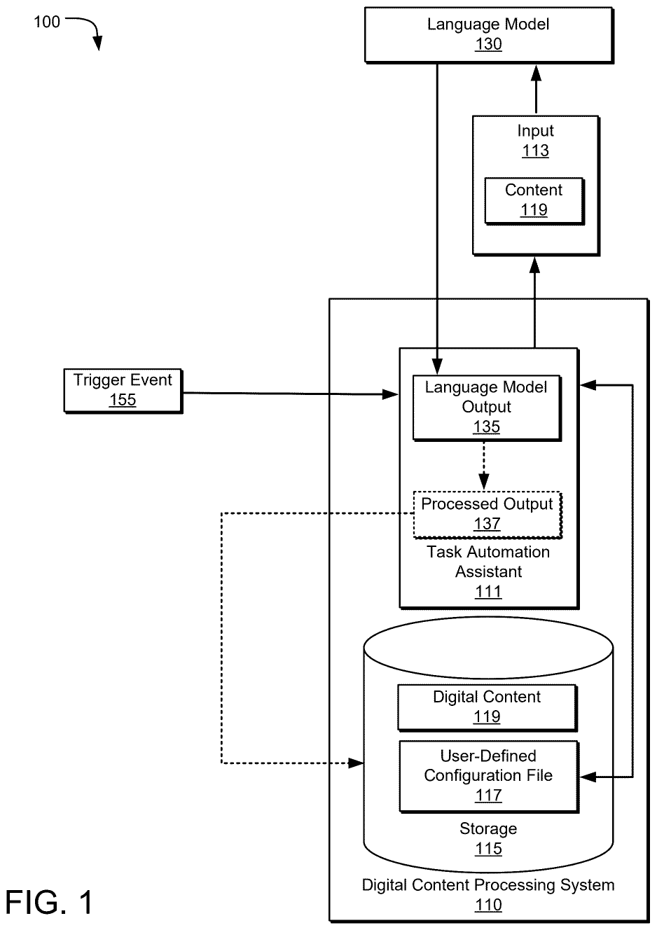

FIG. 1 illustrates an example computing environment 100 in which a digital content processing system 110 processes digital content 119 according to processing steps of an automated workflow specified in a user-defined configuration file 117 responsive to detecting a trigger event 155. The digital content processing system 110 may be an application development system, a data analytics system, an image processing system, a video editing system, a document management system, a cloud computing resource provider system, a presentation design system, or another system that can execute automated workflows involving processing of digital content 119.

The digital content processing system 110 includes a task automation assistant 111 that executes processing operations of automated workflows defined in user-defined configuration files (e.g., the user-defined configuration file 117) responsive to detecting trigger events (e.g., trigger event 155) specified in the user-defined configuration files. In various implementations, the task automation assistant 111 is either part of the digital content processing system 110 or an application executed by the digital content processing system 110. In some implementations, the digital content processing system 110 includes multiple task automation assistants, where each task automation assistant executes processing operations of different types of automated workflows. The task automation assistant 111 accesses, in a storage 115 or other memory of the digital content processing system 110 or otherwise accessible by the digital content processing system 110, user-defined configuration files (e.g., the user-defined configuration file 117) and monitors for the occurrence of the trigger events (e.g., the trigger event 155) that are defined in the user-defined configuration files (e.g., the user-defined configuration file 117).

The storage 115 may include one or more physical or virtual storage mediums that can retain data. The storage 115 stores the user-defined configuration file 117.

The user-defined configuration file 117 defines the parameters of an automated workflow specific to one or more users of the digital content processing system 110. The parameters of the automated workflow specified in the user-defined configuration file 117 include an identification of the trigger event 155, content-identifying information that identifies digital content 119 for the automated workflow in response to the detection of the trigger event 155, user-defined instructions that define a processing task that a language model 130 is to perform on the digital content, and/or output processing instructions that define at least one action to be executed on a language model output 135 of the language model. For example, the processing task and the at least one action are processing operations of the sequence of processing operations of the automated workflow. The user-defined configuration file 117 may define one or more client systems to which processed output 137 of the automated workflow corresponding to the user-defined configuration file 117 is to be routed.

The digital content 119 is specified in the user-defined configuration file 117. In some implementations, the user-defined configuration file 117 specifies one or more of an identifier of the digital content 119, a storage location of the digital content 119, and a file format of the user-defined configuration file 117. In some implementations, as depicted in FIG. 1, the digital content 119 is stored on a storage 115 or memory of the digital content processing system 110. In some implementations, the digital content 119 is stored on a system separate from the digital content processing system 110. For example, the digital content 119 may be stored on a storage device or other memory of a client computing system to which the processed output 137 of the automated workflow is to be routed or on a storage device or other memory of another computing system separate from the digital content processing system 110. The digital content 119 may include textual content (e.g., alphanumeric and/or symbolic characters, words, sentences, etc.). The digital content 119 may include visual content (e.g., images, video), audio data, sensor data, or other types of digital content 119 in addition to the textual content. At least some of the digital content 119 may be used as input to the language model 130.

The trigger event 155 is the occurrence of and/or satisfaction of one or more criteria specified in the user-defined configuration file 117. The user-defined configuration file specifies the trigger event 155 criteria. The criteria may be a list of conditions that must occur. The criteria may specify logical relationships, for example, the trigger event criteria specify “if event A occurs then trigger event is satisfied if event B follows but not if event C follows.” The task automation assistant 111 may monitor for the occurrence of and/or satisfaction of the trigger event 155 criteria responsive to receiving a request, for example, from a client computing system to which processed output 137 or other output of the automated workflow corresponding to the user-defined configuration file 117 is provided.

The one or more criteria of the trigger event 155 may include a wide variety of criteria that define the trigger event 155, for example, user actions (e.g., detection of a form submission, a click/hover/etc. via a user interface provided by the digital content processing system 110 to the user, a user login/logout, a file upload/download, a search query, a profile update, an account creation/deletion), system events of the user (e.g., a threshold CPU usage exceeded, an error rate detected in a process on the user's system, digital content 119 becomes available on the user system, a time zone change on the user system, etc.), temporal criteria (e.g., a start time and/or an end time, a time window, a day of the week, one or more dates, or other temporal criteria), communication related triggers (e.g., message is received via chat/email, a message is opened, a keyword in a communication is detected), service related triggers (e.g., a failure in processing a payment, a change in order status, a stock level drops below a threshold, an invoice becomes overdue), alarm triggers (e.g., a motion sensor detects movement, a temperature sensor detects a threshold temperature, an alarm is triggered, etc.), location based triggers (e.g., a device of the user enters or leaves a geofence), a user-initiated event (e.g., approval received from the user, receiving the digital content 119 from the user, a status change, error message, or other communication received from the user), detection of an availability of the digital content 119 in storage or memory of the digital content processing system 110, an analytical event (e.g., a threshold traffic on the user system is exceeded, an anomaly is detected in a set of data, a particular output of a predictive model is detected), completion of another automated workflow, and/or other criteria.

The task automation assistant 111 accesses the digital content 119 responsive to detecting the trigger event 155. Responsive to detecting the trigger event 155 (e.g., occurrence and/or satisfaction of criteria specified in the user-defined configuration file 117), the task automation assistant 111 may transmit a request to a storage location (e.g., the storage 115 or memory on the digital content processing system 110 or a storage device or memory on another system separate from the digital content processing system 110) with a digital content identifier specified in the user-defined configuration file 117 (e.g., a uniform resource locator (URL) or another identifier(s) that identify the digital content 119 and/or the storage location of the digital content 119) and receive the digital content 119 from the storage location responsive to transmitting the request.

The task automation assistant 111 performs one or more operations of the automated workflow corresponding to the user-defined configuration file 117 using the digital content 119.

In some implementations, as depicted in FIG. 1, performing the operations of the automated workflow include generating inputs (e.g., inputs 113, such as a prompt) for one or more machine learning models (e.g., the language model 130) and receiving outputs (e.g., a language model output 135) from one or more machine learning models. For example, the task automation assistant 111 may generate the inputs 113 for the language model 130 based on parameters specified in the user-defined configuration file 117. For example, the language model 130 may be a large language model (“LLM”), a natural language model (“NLM”), a statistical language model (“SLM”), a contextual language model, a multimodal language model, a specialized language model adapted to a specific knowledge domain, a reinforcement language model, or other language model that can receive the inputs 113 and the digital content 119 as input and provide language model output 135.

In some implementations, the digital content 119 identifies content that the language model 130 is to process to execute a task specified in the input 113. For example, the digital content 119 is an email message and client operating procedures, and the inputs 113 states, “Please detect the customer's problem in the following email message and suggest a solution based on following client operating procedures: [email message], [client operating procedures,]” where [email message] and [client operating procedures] represent insertion of the email message and client operating procedures within the inputs 113. The inputs 113 may reference digital content 119 and the referenced digital content (e.g., digital content 119) is input to the language model 130. For example, the inputs 113 states, “Please respond to the customer's problem in the following email message using information from the following URL: [email message], [URL,]” where [email message] and [URL] represent insertion of the email message and a URL referencing a location of the digital content 119. In another example, the digital content 119 includes a first version of a programming code and a second version of the programming code, and the inputs 113 include an instruction that states, “Process a pull request that identifies and summarizes the difference between the following first version of programming code and second version of the programming code: [first version] and [second version],” where [first version] represents insertion of (or reference to) the first version of the programming code and [second version] represents insertion of (or reference to) the second version of the programming code. In another example, the digital content 119 is a website that publishes, daily, events information (e.g., notices of property foreclosure auctions occurring in a county of a particular state) that include dates, locations and times of events, and the inputs 113 states, “Please generate code for generating calendar events for all of the property foreclosure auctions published on today's date from: [website]. Include a description of the foreclosure auction in each calendar event,” where [website] represents insertion of the website address (e.g. URL) within the inputs 113. In another example, the digital content 119 is a deadline calculator tool that calculates a 90-day deadline from a starting date at website A and website B, which publishes legal notices of a specific type that have a 90-day deadline, and the inputs 113 states “Please compose an email message to client A notifying them of any legal notices issued to them on [website A] and please include a deadline for responding to any deadlines specified in the legal notices using the 90-day deadline calculator of [website B],” where [website A] represents insertion of the website address for accessing the legal notices and where [website B] represents insertion of the website address for accessing the 90-day deadline calculator tool.

In some implementations, the language model 130 is executed on the digital content processing system 110 and the task automation assistant 111 inputs the inputs 113 to the language model 130 and retrieves the language model output 135 of the language model 130. In some implementations, the language model 130 is executed on another system separate from the digital content processing system 110 (e.g., a large language model assistant), and the task automation assistant 111 transmits the inputs 113 to the other system, the other system inputs the inputs 113 to the language model 130, and the task automation assistant 111 receives the language model output 135 from the other system.

The language model 130 generates the language model output 135 based on the inputs 113. The language model output 135 may include one or more of text, image data, video data, audio data, or other data generated as output (e.g., a prediction) responsive to the inputs 113. In one example, the language model output 135 is an email responding to customer concerns in view of accessed client operating procedures. In one example, the language model output 135 is a pull request summary that identifies (and, in some instances, explains) differences between the first version of a programming code and a second version of the programming code. In one example, the language model output 135 is code for generating calendar events for property foreclosure auctions published on today's date. In another example, the language model output 135 is an email advising of a published legal notice to a client and a deadline calculated for responding to the legal notice using a deadline calculator tool.

The task automation assistant 111 may store the language model output 135, for example, in the storage 115.

The task automation assistant 111 may perform further processing steps specified in the user-defined configuration file 117 on the language model output 135 to generate the processed output 137. The task automation assistant 111 may store the processed output 137, for example, in the storage 115. The task automation assistant 111, in some instances, transmits the processed output 137 to a client computing system or otherwise routes the processed output 137 to a device or system specified in the user-defined configuration file 117 corresponding to the automated workflow. For example, for emails generated by the language model output 135, the automated workflow may specify an email address for routing/sending the emails. For example, for code generated for calendar events, the automated workflow may specify adding the calendar events to a calendar application and sending invites to specified parties. The task automation assistant 111, in some instances, transmits the language model output 135 to a client computing system or otherwise routes the language model output 135 to a device or system specified in the user-defined configuration file 117 corresponding to the automated workflow.

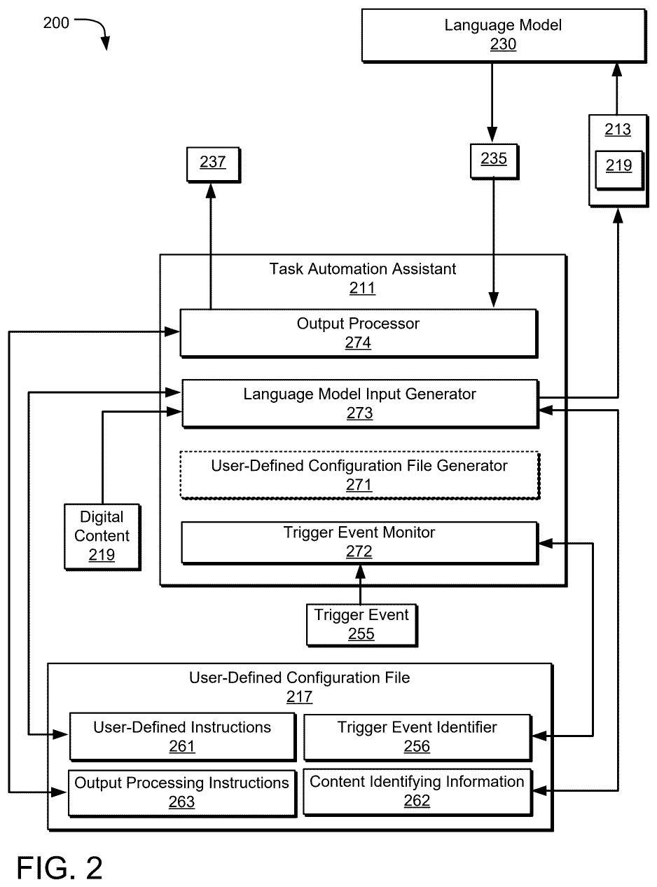

FIG. 2 illustrates an example computing environment 200 in which a task automation assistant 211 processes digital content 219 according to processing steps of an automated workflow specified in a user-defined configuration file 217 responsive to detecting a trigger event 255. The task automation assistant 211 includes application logic that is, in various implementations, executed in different ways. In one implementation, the task automation assistant 211 is a program that is executed by an operating system of a computing device, such as the same computing device that stores the user-defined configuration file 217. In another implementation, the task automation assistant 211 is a web-based application executed by a server remote to the device storing the user-defined configuration file 217. In other implementations, the task automation assistant 211 is an application plug-in that extends the functionality of another application installed on a user device. For example, the task automation assistant 211 may define interface elements that appear on the graphical user interface (GUI) of a development application, email application, word application, or other user application. A user may, for example, interact with the interface elements to define a new instance of the user-defined configuration file 217, such as to provide key parameters that are then used by the task automation assistant 211 to create the user-defined configuration file 217. For example, the task automation assistant 211 creates a new instance of the user-defined configuration file 217 by inserting the parameters received from a user through the application GUI into a template that is then stored in a directory along with other similarly-created configuration files.

The task automation assistant 211 includes the user-defined configuration file generator 271, a trigger event monitor 272, a language model input generator 273, and an output processor 274.

The user-defined configuration file generator 271 generates a user-defined configuration file 217 that specifies the parameters of an automated workflow. The parameters may include user-defined instructions 261, a trigger event identifier 256, content identifying information 262, and output processing instructions 263. The user-defined configuration file generator 271 may generate the user-defined configuration file 217 responsive to a request from a user that requests the generation of a customized automated workflow and provides parameters for generating the user-defined configuration file 217 for the customized automated workflow. For example, the parameters include criteria defining a trigger event, an identification of digital content, instructions for generating inputs for a language model, and instructions for processing an output of the language model. The parameters may be specified by the requesting user. In some implementations, the user-defined configuration file generator 271 may specify default options for one or more parameters in the absence of the user specifying the parameters. For example, the user-defined configuration file generator 271 generates the user-defined configuration file 217 according to parameters specified by the requesting user. In some implementations, the user-defined configuration file generator 271 is a feature or add-on to an application development application provided by the task automation assistant 211. For example, the user-defined configuration file generator 271 provides a user interface including user interface objects (e.g., drop down menus, text input objects, checkboxes, or other user interface objects) for receiving the parameters from the user. The user interacts with the user-defined configuration file generator 271 to provide the parameters via the user interface and the user-defined configuration file generator 271 generates the user-defined configuration file 217 based on the received parameters. In some implementations, the task automation assistant 211 receives the user-defined configuration file 217 from the user and does not generate the user-defined configuration file 217 using the user-defined configuration file generator 271.

The user-defined instructions 261 define a processing task that a language model 230 is to perform on digital content 219. Defining the processing task may include defining a prompt to instruct the language model 230 of the processing task. For example, the prompt is included in the inputs 213 to the language model 230.

The trigger event identifier 256 specifies one or more criteria defining the trigger event 255. The content identifying information 262 identifies digital content 219 for the automated workflow in response to the detection of the trigger event 255. The content identifying information 262 may include the digital content 219 itself or may include a reference (e.g., a URL, a device/storage location, and content identifier) for accessing the digital content 219. The output processing instructions 263 include instructions that define at least one action to be executed on a language model output 235 of the language model 230.

The trigger event monitor 272 monitors for the occurrence of and/or satisfaction of one or more criteria specified in trigger event identifiers (e.g., the trigger event identifier 256) of user-defined configuration files (e.g., the user-defined configuration file 217) accessible to the task automation assistant 211. For example, detection of the occurrence of and/or satisfaction of the one or more specified criteria signifies the occurrence of a trigger event (e.g., the trigger event 255). Monitoring for the one or more criteria may include monitoring inputs received through a development application of the digital content processing system to detect instances of the trigger event and to detect the trigger event via the monitoring.

In response to detection of the trigger event 255 by the trigger event monitor 272, the language model input generator 273 accesses digital content 219 (or accesses a reference to digital content 219) specified by content identifying information 262 of the user-defined configuration file 217. For example, the content identifying information 262 may specify the digital content 219 using a file name, a URL, or other identifier. In some instances, the digital content 219 is a subset of a larger body of data and the content identifying information 262 specifies (e.g., using a file name, URL, or other identifier) the larger body of data and also specifies (e.g., using a range) the subset. For example, the digital content 219 is the first two columns of a table and the content identifying information 262 includes a file name identifying the table as well as column identifiers “A” and “B” identifying the first two columns of the table. The language model input generator 273 generates the inputs 213 in accordance with the user-defined instructions 261 that instruct the language model 230 to process the digital content 219. The language model input generator 273 inputs the inputs 213, including the digital content 219 (or including a reference to the digital content 219), to the language model 230.

The output processor 274 accesses the language model output 235 of the language model 230 processes the language model output 235 in accordance with the output processing instructions 263 specified in the user-defined configuration file 217. Processing the language model output 235 may involve routing the language model output 235 to a client computing system. Processing the language model output 235 may involve generating processed output 237 based on the language model output 235. For example, the output processor 274 may format, synthesize, delete from, add to, rearrange, insert into a data structure, or otherwise process the language model output 235 to generate the processed output 237. In some implementations, the output processor 274, as indicated in FIG. 2, outputs (e.g., transmits to a client computing system or to another system) the processed output 237.

In an example, the user-defined configuration file 217 defines an automated workflow for processing a pull request that analyzes and explains changes that occur between versions of programming code. The user-defined configuration file 217 includes a trigger event identifier 256 that identifies 5:00 p.m. each Friday as a trigger event 255 for processing the pull request. The content identifying information 262 identifies a file name of a file that stores the program code. The user-defined instructions 261 specify inputs to the language model 230 that instruct the language model 230 to compare the current version of the program code to a previous version of the program code (e.g., the program code as it was at 5:00 p.m. on the previous Friday). The output processing instructions 263 instruct the task automation assistant 211 to insert the output of the language model 230 (e.g., the comparison and explanation of the changes to the program code) into a formatted template and to save the formatted template as a pdf file in two specific locations and to transmit the pdf file to another system (e.g., to a client computing device). In this example, the trigger event monitor 272 monitors for the occurrence of the trigger event 255 by monitoring a clock accessible to the trigger event monitor 272. The language model input generator 273 generates inputs for the language model 230 by accessing the digital content using content identifying information 262 and transmitting inputs 212 (e.g., a prompt and the digital content 219) to the language model 230. For example, the inputs 212 include a prompt that states “please generate a text output that identifies changes between the current version of the programming code of FileNameA and the previous version of the programming code of FileNameA and that explains these changes” and the digital content 219. The output processor 274 receives or otherwise accesses language model output 235 of the language model 230. For example, the language model output 235 includes the text output that is requested in the inputs 212 to the language model 230. For example, the text output is a five-paragraph summary. The output processor 274, in accordance with the output processing instructions 263 of the user-defined configuration file 217, inserts the output of the language model 230 into a formatted template as specified in the output processing instructions 263 (e.g., the template includes images and a boilerplate message above which the language model output 235 is inserted), saves the formatted template as a pdf file in the two specific locations specified in the output processing instructions 263, and transmits the pdf file to the other system specified in the output processing instructions 263.

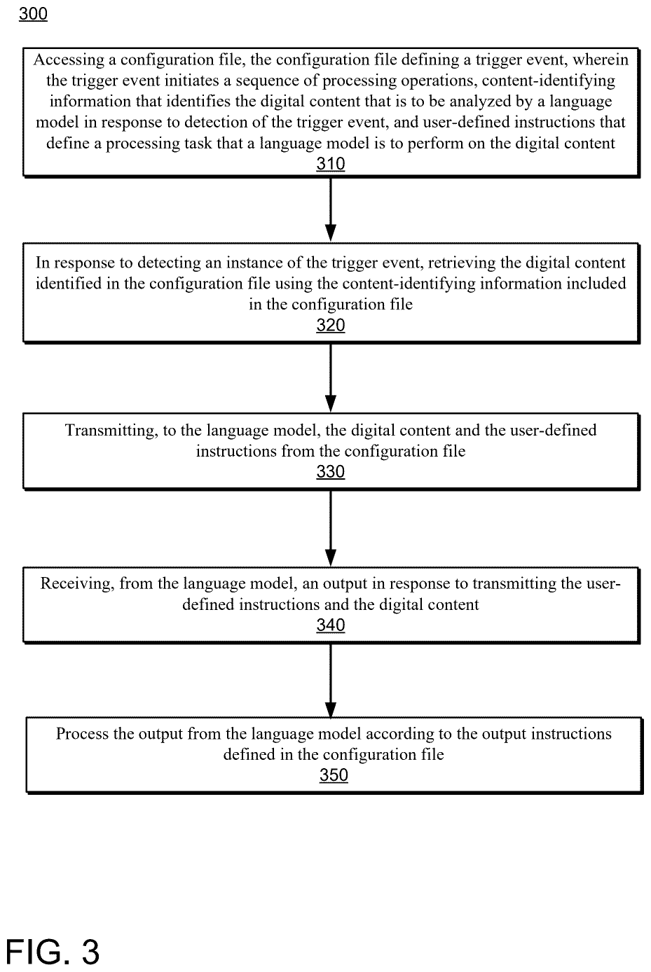

FIG. 3 illustrates examples of operations 300 that process digital content responsive to a trigger event, comprising.

An accessing operation 310 accesses a configuration file, the configuration file defining a trigger event, wherein the trigger event initiates a sequence of processing operations, content-identifying information that identifies the digital content that is to be analyzed by a language model in response to detection of the trigger event, and user-defined instructions that define a processing task that a language model is to perform on the digital content. In some implementations, the user-defined configuration file further defines output processing instructions that define at least one action to be executed on an output of the language model, and further comprising processing the output from the language model according to the output processing instructions defined in the configuration file. In some implementations, the content-identifying information identifies a location of the digital content and a portion of the digital content, wherein inputting the digital content to the language model comprises inputting the identified portion of the digital content.

A retrieving operation 320 retrieves, responsive to detecting an instance of the trigger event, the digital content identified in the configuration file using the content-identifying information included in the configuration file. In some implementations, monitoring for the trigger event includes monitoring inputs received through a development application to detect instances of the trigger event and to detect the trigger event via the monitoring.

A transmitting operation 330 transmits, to the language model, the digital content and the user-defined instructions from the configuration file. In some implementations, the user-defined instructions define inputs for a language model and a description of a desired output to the language model, wherein the language model generates the output in accordance with the description of the desired output. In some implementations, the user-defined instructions define that the process requires user approval, and further comprising requesting approval of the process from a client computing device, wherein the digital content is input to the language model further responsive to receiving the approval from the client computing device.

A receiving operation 340 receives, from the language model, an output in response to transmitting the user-defined instructions and the digital content. In some implementations, the digital content comprises a first version and a second version of code and wherein the output of the language model includes an identification of differences between the first version of the code and the second version of the code.

A processing operation 350 processes the output from the language model according to the output instructions defined in the configuration file.

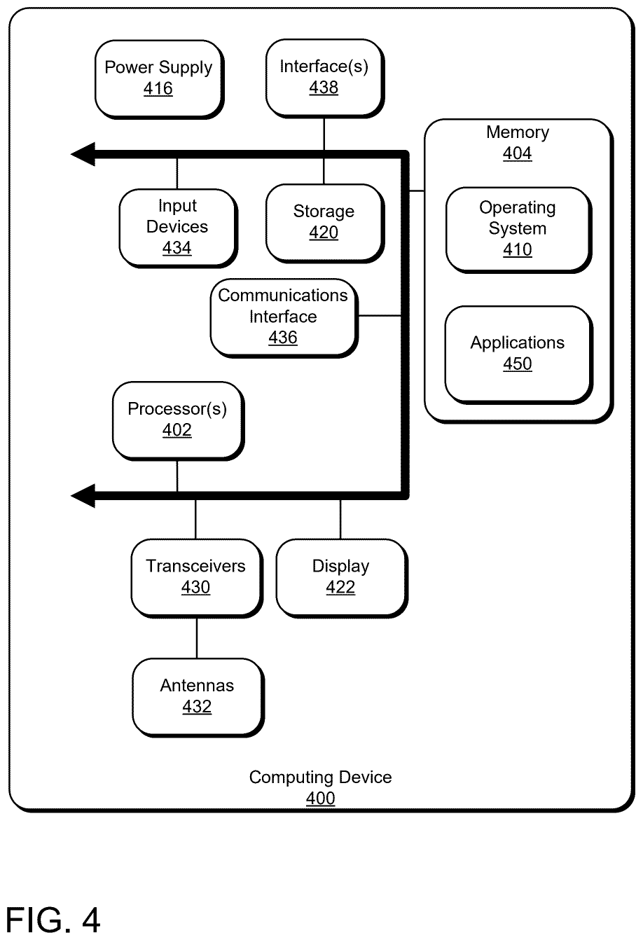

FIG. 4 illustrates an example computing device 400 for implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes one or more hardware processor(s) 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processor(s) 402. In some implementations, the computing device 400 includes and/or is communicatively coupled to storage 420.

In the example computing device 400, as shown in FIG. 4, one or more software modules, segments, and/or processors, such as a task automation assistant, a trigger event monitor, a user-defined configuration file manager, a language model input generator, an output processor, applications 450, and other program code and modules are loaded into the operating system 410 on the memory 404 and/or the storage 420 and executed by the processor(s) 402. The storage 420 may store data (e.g., including one or more user-defined configuration files, digital content, language models, and other data) and be local to the computing device 400 or may be remote and communicatively connected to the computing device 400. In particular, in one implementation, components of a system for reducing energy usage of a client network may be implemented entirely in hardware or in a combination of hardware circuitry and software.

The computing device 400 includes a power supply 416, which may include or be connected to one or more batteries or other power sources and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices). The computing device 400 may use the adapter and any other types of communication devices for establishing connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A system for processing digital content responsive to a trigger event, comprising: a user-defined configuration file stored in memory defining: the trigger event, wherein a detection of the trigger event initiates a sequence of processing operations; content-identifying information that identifies the digital content in response to detection of the trigger event, wherein the content-identifying information identifies a location of the digital content; and user-defined instructions that define a processing task that a language model is to perform on the digital content, wherein the user-defined instructions define inputs to the language model and a description of a desired output to the language model; and output processing instructions that define at least one action to be executed on an output of the language model; and a task automation assistant stored in memory and executable by a processor to: in response to detecting the trigger event, retrieve the digital content identified in the user-defined configuration file from the identified location using the content-identifying information; input, to the language model, the digital content and the user-defined instructions from the user-defined configuration file; and receive the output from the language model specified in the description of the desired output in response to transmission of the user-defined instruction and the digital content. process the output from the language model according to the output processing instructions defined in the user-defined configuration file.

Clause 2. The system of clause 1, wherein the task automation assistant is further executable by the processor to monitor inputs received through a development application to detect instances of the trigger event and to detect the trigger event via the monitoring.

Clause 3. The system of clause 1, wherein the user-defined configuration file further defines output processing instructions that define at least one action to be executed on an output of the language model, wherein the task automation assistant is further executable by the processor to process the output from the language model according to the output processing instructions defined in the user-defined configuration file.

Clause 4. The system of clause 1, wherein the content-identifying information identifies a portion of the digital content, wherein inputting the digital content to the language model comprises inputting the identified portion of the digital content.

Clause 5. The system of clause 1, wherein the digital content includes published events information and wherein the output of the language model includes code for generating calendar events based on the published events information.

Clause 6. The system of clause 1, wherein the trigger event specifies a user approval, wherein detecting the trigger event includes detecting the user approval, wherein the task automation assistant is further executable by the processor to request the user approval from a client computing device, wherein the task automation assistant detects the user approval responsive to receiving the user approval from the client computing device.

Clause 7. The system of clause 1, wherein the digital content comprises a first version and a second version of code and wherein the output of the language model includes an identification of differences between the first version of the code and the second version of the code.

Clause 8. A method for processing digital content responsive to trigger a trigger event, comprising: accessing a configuration file stored in memory, the configuration file defining: the trigger event, wherein a detection of the trigger event initiates a sequence of processing operations; content-identifying information that identifies the digital content that is to be analyzed by a language model in response to detection of the trigger event, wherein the content-identifying information identifies a location of the digital content; user-defined instructions that define a processing task that the language model is to perform on the digital content, wherein the user-defined instructions define inputs to the language model and a description of a desired output to the language model; in response to detecting the trigger event, retrieving the digital content identified in the configuration file using the content-identifying information included in the configuration file; transmitting, to a language model, the digital content and the user-defined instructions from the configuration file; and receiving, from the language model, an output specified in the description of the desired output in response to transmitting the user-defined instruction and the digital content.

Clause 9. The method of clause 8, further comprising monitoring inputs received through a development application to detect instances of the trigger event and to detect the trigger event via the monitoring.

Clause 10. The method of clause 8, wherein the configuration file further defines output processing instructions that define at least one action to be executed on an output of the language model, and further comprising processing the output from the language model according to the output processing instructions defined in the configuration file.

Clause 11. The method of clause 8, wherein the content-identifying information identifies a portion of the digital content, wherein inputting the digital content to the language model comprises inputting the identified portion of the digital content.

Clause 12. The method of clause 8, wherein the digital content includes published events information and wherein the output of the language model includes code for generating calendar events based on the published events information.

Clause 13. The method of clause 8, wherein the trigger event specifies a user approval, wherein detecting the trigger event includes detecting the user approval, and further comprising requesting the user approval from a client computing device and detecting the user approval responsive to receiving the user approval from the client computing device.

Clause 14. The method of clause 8, wherein the digital content comprises a first version and a second version of code and wherein the output of the language model includes an identification of differences between the first version of the code and the second version of the code.

Clause 15. One or more tangible processor-readable storage media embodied with instructions for executing on one or more processors and circuits of a computing device a process for processing digital content responsive to a trigger event, the process comprising: accessing a configuration file stored in memory, the configuration file defining: the trigger event, wherein a detection of the trigger event initiates a sequence of processing operations; content-identifying information that identifies the digital content that is to be analyzed by a language model in response to detection of the trigger event, wherein the content-identifying information identifies a location of the digital content; user-defined instructions that define a processing task that the language model is to perform on the digital content, wherein the user-defined instructions define inputs to the language model and a description of a desired output to the language model; in response to detecting the trigger event, retrieving the digital content identified in the configuration file using the content-identifying information included in the configuration file; transmitting, to a language model, the digital content and the user-defined instructions from the configuration file; receiving, from the language model, an output specified in the description of the desired output in response to transmitting the user-defined instruction and the digital content.

Clause 16. The one or more tangible processor-readable storage media of clause 15, the process further comprising monitoring inputs received through a development application to detect instances of the trigger event and to detect the trigger event via the monitoring.

Clause 17. The one or more tangible processor-readable storage media of clause 15, wherein the configuration file further defines output processing instructions that define at least one action to be executed on an output of the language model, and the process further comprising processing the output from the language model according to the output processing instructions defined in the configuration file.

Clause 18. The one or more tangible processor-readable storage media of clause 15, wherein the content-identifying information identifies a portion of the digital content, wherein inputting the digital content to the language model comprises inputting the identified portion of the digital content.

Clause 19. The one or more tangible processor-readable storage media of clause 15, wherein the digital content includes published events information and wherein the output of the language model includes code for generating calendar events based on the published events information.

Clause 20. The one or more tangible processor-readable storage media of clause 15, wherein the trigger event specifies a user approval, wherein detecting the trigger event includes detecting the user approval, and the process further comprises requesting approval of the process from a client computing device, wherein detecting the user approval includes receiving the approval from the client computing device.

Clause 21. A system for processing digital content responsive to trigger a trigger event, comprising: means for accessing a configuration file stored in memory, the configuration file defining: the trigger event, wherein a detection of the trigger event initiates a sequence of processing operations; content-identifying information that identifies the digital content that is to be analyzed by a language model in response to detection of the trigger event, wherein the content-identifying information identifies a location of the digital content; user-defined instructions that define a processing task that the language model is to perform on the digital content, wherein the user-defined instructions define inputs to the language model and a description of a desired output to the language model; means for retrieving, in response to detecting the trigger event, the digital content identified in the configuration file using the content-identifying information included in the configuration file; means for transmitting, to a language model, the digital content and the user-defined instructions from the configuration file; and means for receiving, from the language model, an output specified in the description of the desired output in response to transmitting the user-defined instruction and the digital content.

Clause 22. The system of clause 21, further comprising means for monitoring inputs received through a development application to detect instances of the trigger event and to detect the trigger event via the monitoring.

Clause 23. The system of clause 21, wherein the configuration file further defines output processing instructions that define at least one action to be executed on an output of the language model, and further comprising means for processing the output from the language model according to the output processing instructions defined in the configuration file.

Clause 24. The system of clause 21, wherein the content-identifying information identifies a portion of the digital content, wherein the means for inputting the digital content to the language model comprises means for inputting the identified portion of the digital content.

Clause 25. The system of clause 21, wherein the digital content includes published events information and wherein the output of the language model includes code for generating calendar events based on the published events information.

Clause 26. The system of clause 21, wherein the trigger event specifies a user approval, wherein the means for detecting the trigger event includes means for detecting the user approval, and further comprising means for requesting the user approval from a client computing device and detecting the user approval responsive to receiving the user approval from the client computing device.

Clause 27. The system of clause 21, wherein the digital content comprises a first version and a second version of code and wherein the output of the language model includes an identification of differences between the first version of the code and the second version of the code.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A system for processing digital content responsive to a trigger event, comprising:
a user-defined configuration file stored in memory defining:
the trigger event, wherein a detection of the trigger event initiates a sequence of processing operations;
content-identifying information that identifies the digital content in response to detection of the trigger event, wherein the content-identifying information identifies a location of the digital content; and
user-defined instructions that define a processing task that a language model is to perform on the digital content, wherein the user-defined instructions define inputs to the language model and a description of a desired output to the language model; and
output processing instructions that define at least one action to be executed on an output of the language model; and
a task automation assistant stored in memory and executable by a processor to:
in response to detecting the trigger event, retrieve the digital content identified in the user-defined configuration file from the identified location using the content-identifying information;
input, to the language model, the digital content and the user-defined instructions from the user-defined configuration file; and
receive the output from the language model specified in the description of the desired output in response to transmission of the user-defined instruction and the digital content; and
process the output from the language model according to the output processing instructions defined in the user-defined configuration file.

2. The system of claim 1, wherein the task automation assistant is further executable by the processor to monitor inputs received through a development application to detect instances of the trigger event and to detect the trigger event via the monitoring.

3. The system of claim 1, wherein the user-defined configuration file further defines output processing instructions that define at least one action to be executed on an output of the language model, wherein the task automation assistant is further executable by the processor to process the output from the language model according to the output processing instructions defined in the user-defined configuration file.

4. The system of claim 1, wherein the content-identifying information identifies a portion of the digital content, wherein inputting the digital content to the language model comprises inputting the identified portion of the digital content.

5. The system of claim 1, wherein the digital content includes published events information and wherein the output of the language model includes code for generating calendar events based on the published events information.

6. The system of claim 1, wherein the trigger event specifies a user approval, wherein detecting the trigger event includes detecting the user approval, wherein the task automation assistant is further executable by the processor to request the user approval from a client computing device, wherein the task automation assistant detects the user approval responsive to receiving the user approval from the client computing device.

7. The system of claim 1, wherein the digital content comprises a first version and a second version of code and wherein the output of the language model includes an identification of differences between the first version of the code and the second version of the code.

8. A method for processing digital content responsive to trigger a trigger event, comprising:
accessing a configuration file stored in memory, the configuration file defining:
the trigger event, wherein a detection of the trigger event initiates a sequence of processing operations;
content-identifying information that identifies the digital content that is to be analyzed by a language model in response to detection of the trigger event, wherein the content-identifying information identifies a location of the digital content;
user-defined instructions that define a processing task that the language model is to perform on the digital content, wherein the user-defined instructions define inputs to the language model and a description of a desired output to the language model;
in response to detecting the trigger event, retrieving the digital content identified in the configuration file using the content-identifying information included in the configuration file;
transmitting, to a language model, the digital content and the user-defined instructions from the configuration file; and
receiving, from the language model, an output specified in the description of the desired output in response to transmitting the user-defined instruction and the digital content.

9. The method of claim 8, further comprising monitoring inputs received through a development application to detect instances of the trigger event and to detect the trigger event via the monitoring.

10. The method of claim 8, wherein the configuration file further defines output processing instructions that define at least one action to be executed on an output of the language model, and further comprising processing the output from the language model according to the output processing instructions defined in the configuration file.

11. The method of claim 8, wherein the content-identifying information identifies a portion of the digital content, wherein inputting the digital content to the language model comprises inputting the identified portion of the digital content.

12. The method of claim 8, wherein the digital content includes published events information and wherein the output of the language model includes code for generating calendar events based on the published events information.

13. The method of claim 8, wherein the trigger event specifies a user approval, wherein detecting the trigger event includes detecting the user approval, and further comprising requesting the user approval from a client computing device and detecting the user approval responsive to receiving the user approval from the client computing device.

14. The method of claim 8, wherein the digital content comprises a first version and a second version of code and wherein the output of the language model includes an identification of differences between the first version of the code and the second version of the code.

15. One or more tangible processor-readable storage media embodied with instructions for executing on one or more processors and circuits of a computing device a process for processing digital content responsive to a trigger event, the process comprising:
accessing a configuration file stored in memory, the configuration file defining:
the trigger event, wherein a detection of the trigger event initiates a sequence of processing operations;
content-identifying information that identifies the digital content that is to be analyzed by a language model in response to detection of the trigger event, wherein the content-identifying information identifies a location of the digital content;
user-defined instructions that define a processing task that the language model is to perform on the digital content, wherein the user-defined instructions define inputs to the language model and a description of a desired output to the language model;
in response to detecting the trigger event, retrieving the digital content identified in the configuration file using the content-identifying information included in the configuration file;
transmitting, to a language model, the digital content and the user-defined instructions from the configuration file;
receiving, from the language model, an output specified in the description of the desired output in response to transmitting the user-defined instruction and the digital content.

16. The one or more tangible processor-readable storage media of claim 15, the process further comprising monitoring inputs received through a development application to detect instances of the trigger event and to detect the trigger event via the monitoring.

17. The one or more tangible processor-readable storage media of claim 15, wherein the configuration file further defines output processing instructions that define at least one action to be executed on an output of the language model, and the process further comprising processing the output from the language model according to the output processing instructions defined in the configuration file.

18. The one or more tangible processor-readable storage media of claim 15, wherein the content-identifying information identifies a portion of the digital content, wherein inputting the digital content to the language model comprises inputting the identified portion of the digital content.

19. The one or more tangible processor-readable storage media of claim 15, wherein the digital content includes published events information and wherein the output of the language model includes code for generating calendar events based on the published events information.

20. The one or more tangible processor-readable storage media of claim 15, wherein the trigger event specifies a user approval, wherein detecting the trigger event includes detecting the user approval, and the process further comprises requesting approval of the process from a client computing device, wherein detecting the user approval includes receiving the approval from the client computing device.
